(19) United States
(12) Patent Application Publication
(10) Pub. No.: US 2014/0313203 A1
(43) Pub. Date: Oct. 23, 2014

(54) Virtual Structural Staging System and Method of Use

(71) Applicant: KTS Solutions, LLC, Rosharon, TX (US)

(72) Inventor: Kyle SHUGART, Rosharon, TX (US)

(73) Assignee: KTS Solutions, LLC, Rosharon, TX (US)

(21) Appl. No.: 14/258,009

(22) Filed: Apr. 21, 2014

Related U.S. Application Data
(60) Provisional application No. 61/814,123, filed on Apr. 19, 2013.

(51) Int. Cl. G06T 15/08

(52) U.S. Cl. CPC G06T 15/08
USPC 345/427

(57) ABSTRACT

An apparatus is disclosed comprising at least a one memory of a one or more computers including a computer program code comprising a virtual structural staging system; and at least one processor. Said at least one memory and the computer program code are configured to, with the at least one processor, cause the apparatus at least to capture a one or more digital images of a house having a floor plan; map a plurality of virtual vertices of a rendered 3D floor plan over a plurality of picture vertices of said one or more digital images; and render said rendered 3D floor plan in said virtual structural staging system on said at least one processor.

### CROSS-REFERENCE TO RELATED APPLICATIONS

This application is a nonprovisional filed on the basis and claiming the benefit of provisional U.S. patent application No. 61/814,123, filed on Apr. 19, 2013. That application is hereby incorporated by reference. This application is made on Apr. 21, 2014, which is the first day the USPTO is open after the anniversary of that provisional application and is therefore filed timely.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure includes a system, a method and a computer program as follows.

Said system relates generally to a virtual structural staging system and method of use. None of the known inventions and patents, taken either singularly or in combination, is seen to describe the instant disclosure as claimed. Accordingly, an improved virtual structural staging system and method of use would be advantageous.

A method for processing a virtual structural staging system, the method comprising: capturing a one or more digital images of a house having a floor plan; mapping a plurality of virtual vertices of a rendered 3D floor plan over a plurality of picture vertices of said one or more digital images; and rendering said rendered 3D floor plan in said virtual structural staging system.

A computer program product embodied on a non-transitory computer readable storage medium, the computer program product being encoded with instructions to control a processor to perform a process, the process comprising:

### BRIEF SUMMARY OF THE INVENTION

An apparatus is disclosed comprising at least a one memory of a one or more computers including a computer program code comprising a virtual structural staging system; and at least one processor. Said at least one memory and the computer program code are configured to, with the at least one processor, cause the apparatus at least to capture a one or more digital images of a house having a floor plan; map a plurality of virtual vertices of a rendered 3D floor plan over a plurality of picture vertices of said one or more digital images; and render said rendered 3D floor plan in said virtual structural staging system on said at least one processor.

### BRIEF DESCRIPTION OF THE SEVERAL VIEWS OF THE DRAWING

FIG. 1 illustrates a first network configuration of a virtual structural staging system.

FIGS. 2A, 2B and 2C illustrate a perspective overview of a mobile phone, a personal computer and a mobile computer.

FIG. 3 illustrates a perspective overview of a house and an elevated front view of said mobile computer.

FIGS. 4A, 4B and 4C illustrate an elevated top view of a floor plan displayed on a sheet of paper, an elevated perspective front view of said mobile computer displaying a digital image of a floor plan and an elevated front view of a digitized floor plan rendered on said mobile computer.

FIGS. 5A and 5B illustrate a perspective overview of said mobile computer taking a digital image said second room (comprising a subject matter), and said first room.

FIGS. 6A, 6B, 6C and 6D illustrate an elevated front view said mobile computer comprising said virtual structural staging system a perspective overview of said second room; first as an original image of an empty room, next as a first rendered image comprising a flooring, then as a second rendered image comprising a wall decor, and finally as a third rendered image comprising a one or more furniture pieces (which can comprise a couch, a coffee table and a kitchen table).

FIGS. 7A and 7B illustrate an elevated front view said mobile computer comprising said first room comprising a portion of said interior of said house with different variations of a one or more window treatments.

FIGS. 8A, 8B, 8C and 8D illustrate an elevated front view said mobile computer comprising a rendered 3D floor plan (comprising perspective 3-dimensional overview of said house); a first rendering with said house being empty, a second rendering comprising the addition of a plurality of said flooring, a third rendering further comprising a plurality of said one or more furniture pieces, and a fourth rendering showing a detailed view of said second room.

FIGS. 9A and 9B illustrate an elevated front view said mobile computer comprising said rendered 3D floor plan further comprising an avatar displayed as touring said rendered 3D floor plan.

### DETAILED DESCRIPTION OF THE INVENTION

Described herein is a virtual structural staging system and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

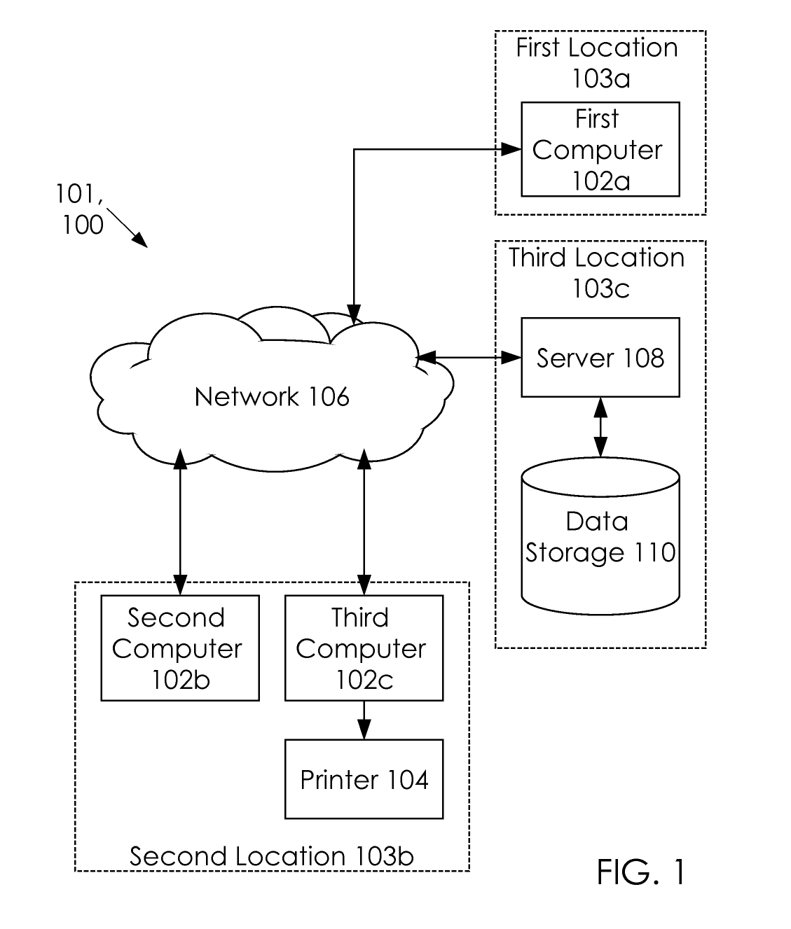

FIG. 1 illustrates a first network configuration 101 of a virtual structural staging system 100. In one embodiment, said virtual structural staging system 100 can comprise a one or more computers at a one or more locations. In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

In one embodiment, said virtual structural staging system 100 can capture files on said first computer 102a, render them on one or more servers (such as said server 108) and display them on said second computer 102b. Accordingly, a workload and library of digital assets can be created and distributed across said network 106.

In one embodiment, said virtual structural staging system 100 can comprise a computer program code running in at least one memory of said one or more computers; wherein, said one or more computers can comprise at least one processors

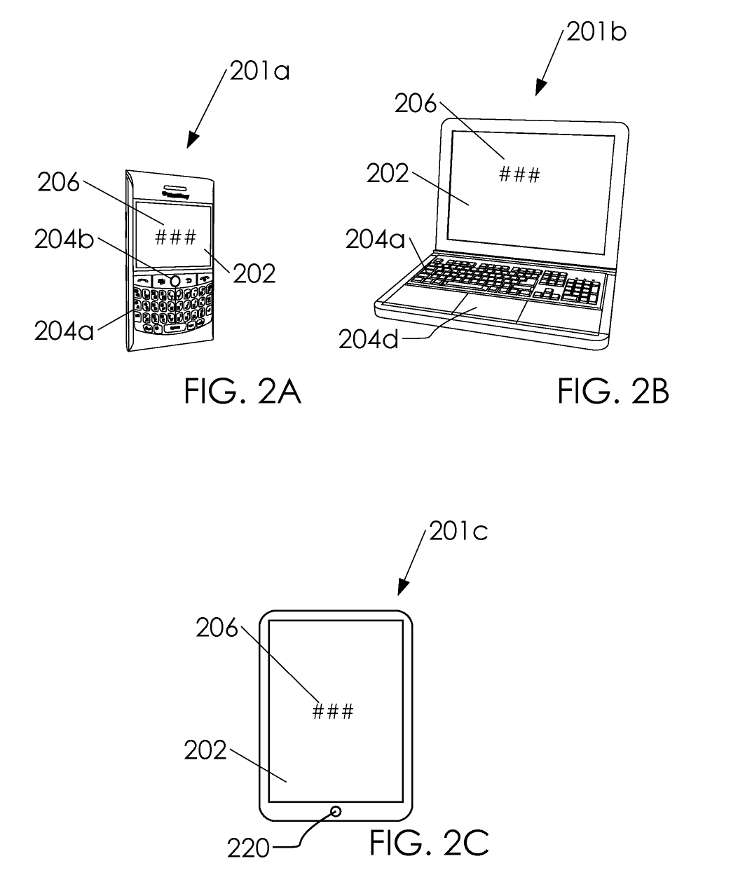

FIGS. 2A, 2B and 2C illustrate a perspective overview of a mobile phone 201 a, a personal computer 201 b and a mobile computer 201 c. In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said mobile computer 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said mobile computer 201c and/or said personal computer 201b can comprise a Microsoft® Windows® branded device, an Apple® branded device, or similar. In one embodiment, said mobile computer 201c can be an X86 type processor or an ARM type processor, as is known in the art.

Said virtual structural staging system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

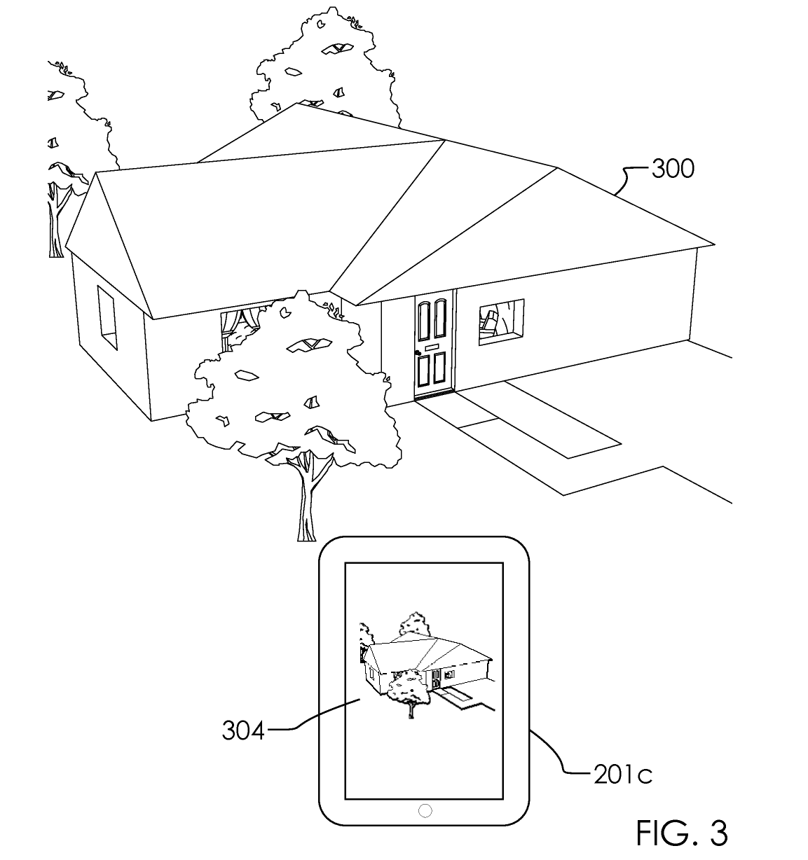

FIG. 3 illustrates a perspective overview of a house 300 and an elevated front view of said mobile computer 201c. In one embodiment, said mobile computer 201c can comprise an exterior digital image 304 of said house 300.

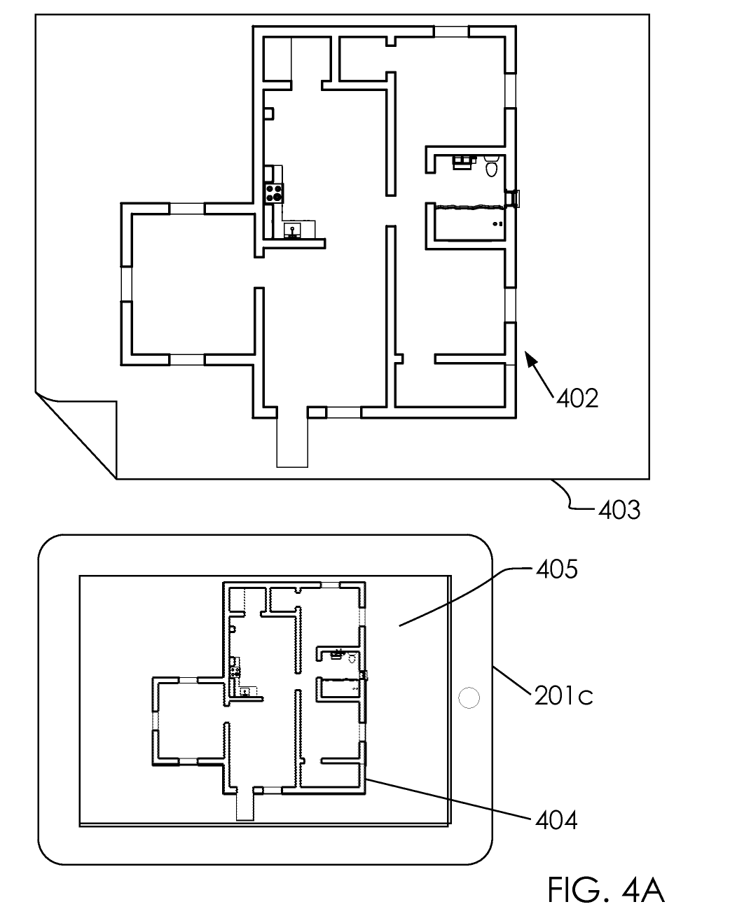

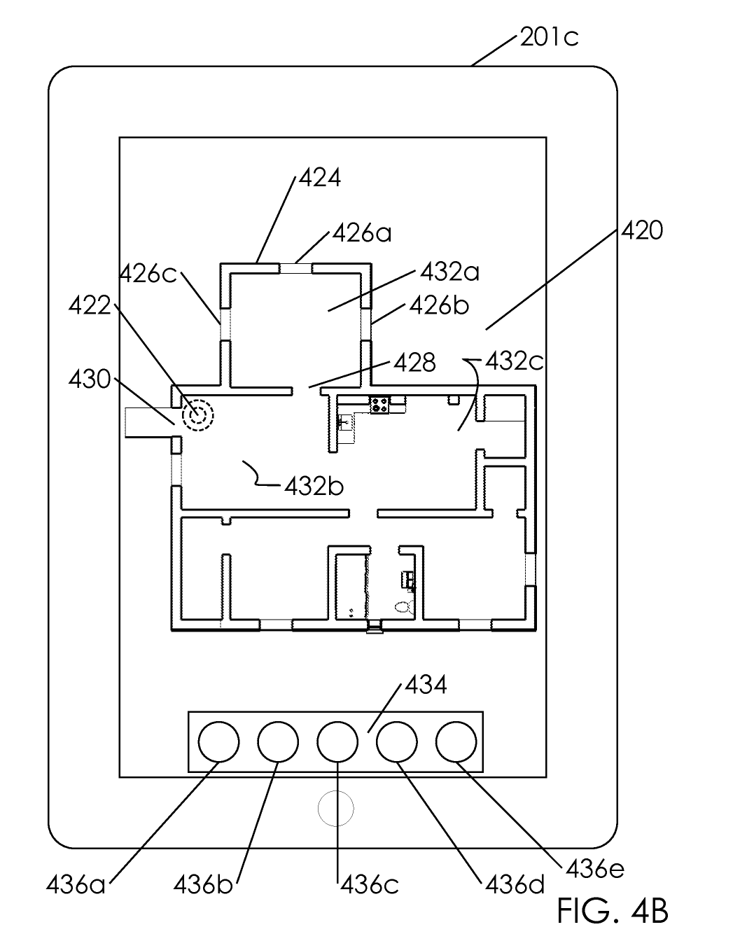

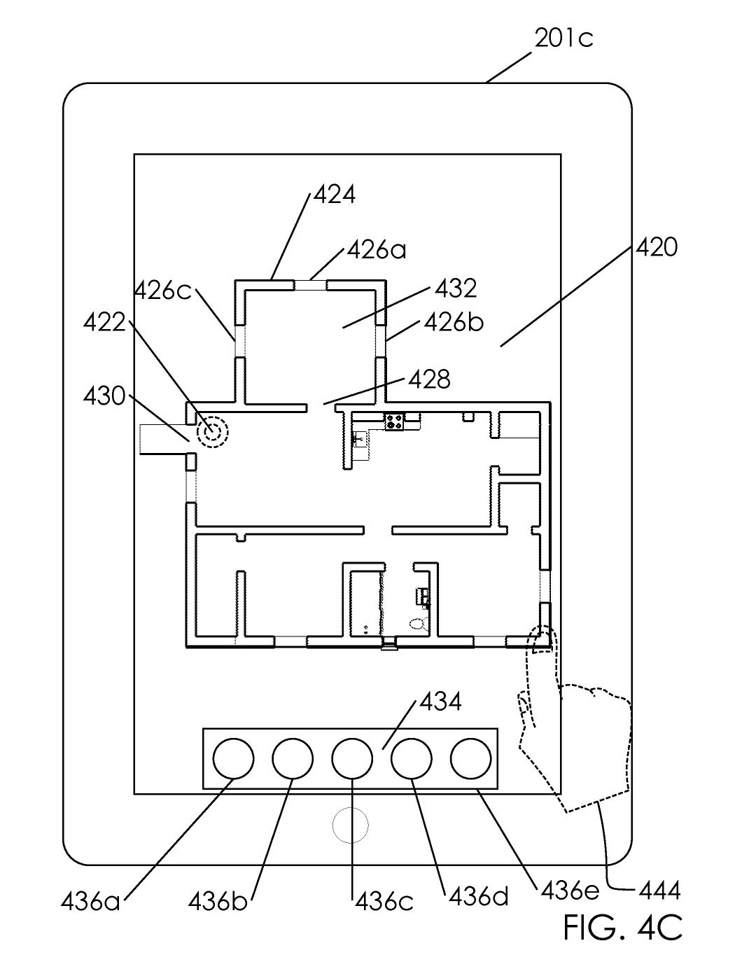

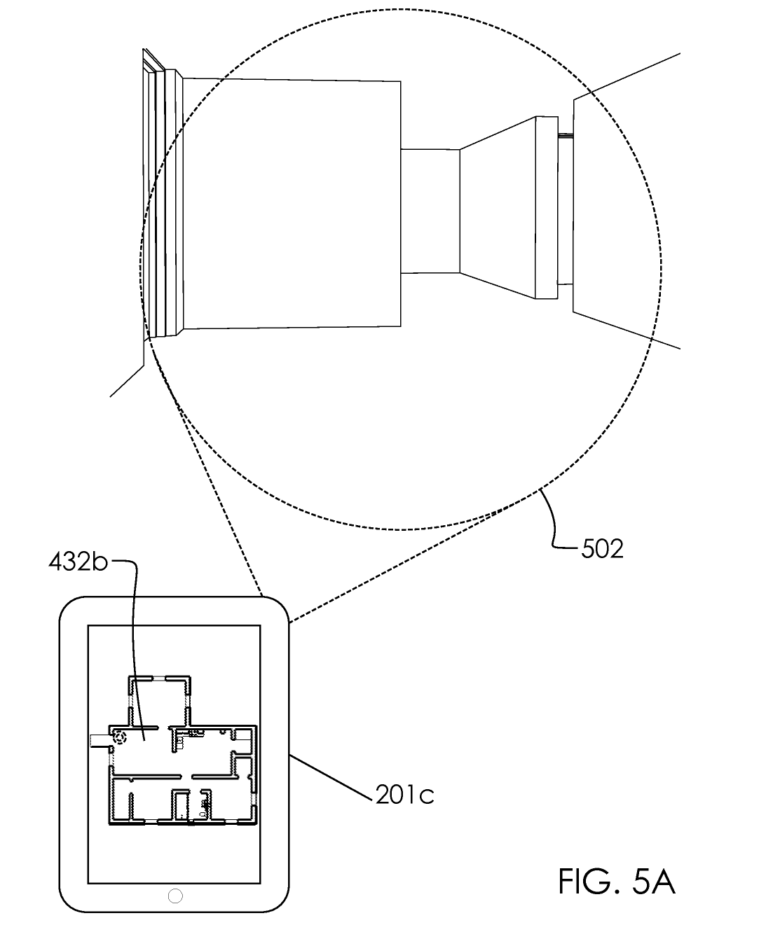

FIGS. 4A, 4B and 4C illustrate an elevated top view of a floor plan 402 displayed on a sheet of paper 403, an elevated perspective front view of said mobile computer 201c displaying a digital image 405 of a floor plan 404 and an elevated front view of a digitized floor plan 420 rendered on said mobile computer 201c.

As illustrated in FIG. 4A, taking said digital image 405 of said floor plan 402 can comprise using said one or more cameras 204c of said mobile computer 201c to capture an image of said floor plan 402. In one embodiment, said mobile computer 201c can take and display said digital image 405 of said floor plan 404.

As illustrate in FIG. 4B, said digital image 405 can be used to further capture data related to said house 300. As a navigation utility, said virtual structural staging system 100 can comprise a one or more user interface utilities. For example, in one embodiment, said digitized floor plan 420 can comprise a location icon 422, a one or more walls, such as a wall 424 and a one or more rooms, such as a first room 432a, a second room 432b and a third room 432c. In one embodiment, said one or more walls can comprise a one or more windows, such as a first window 426a, a second window 426b, a third window 426c, a one or more interior doorways, such as interior doorway 428 and a one or more exterior doorways, such as exterior doorway 430. In one embodiment, said mobile computer 201c can comprise a software task bar 434.

In one embodiment, said software task bar 434 can comprise a one or more buttons. In one embodiment, said one or more buttons can comprise a first button 436a, a second button 436b, a third button 436c, a fourth button 436d and a fifth button 436e. In one embodiment, said one or more buttons can be used for a plurality of different purposes. For example, in one embodiment, said first button 436a can be used to take a digital image (such as said digital image 405). In one embodiment, said second button 436b can be used to add or delete utilities and/or fixtures, such as a toilet, a shower and household appliances, such as a stove top, an oven or a dishwasher. In one embodiment, said third button 436c can be used to add or delete said one or more walls. In one embodiment, said fourth button 436d can be used to add or delete a type of window treatment. In one embodiment, said fifth button can be used to add or delete said one or more interior or exterior doorways.

Furthermore, in one embodiment, a user can trace out boundaries of said one or more rooms (one or more walls) after said digital image 405 has been “scanned” (that is taking a picture of said sheet of paper 403 or scanning with a scanner). In one embodiment, said user can draw a floor plan from scratch without said floor plan 402. In one embodiment, said virtual structural staging system 100 can utilize a touch input (signaled here by a hand 444 and a movement arrow 446).

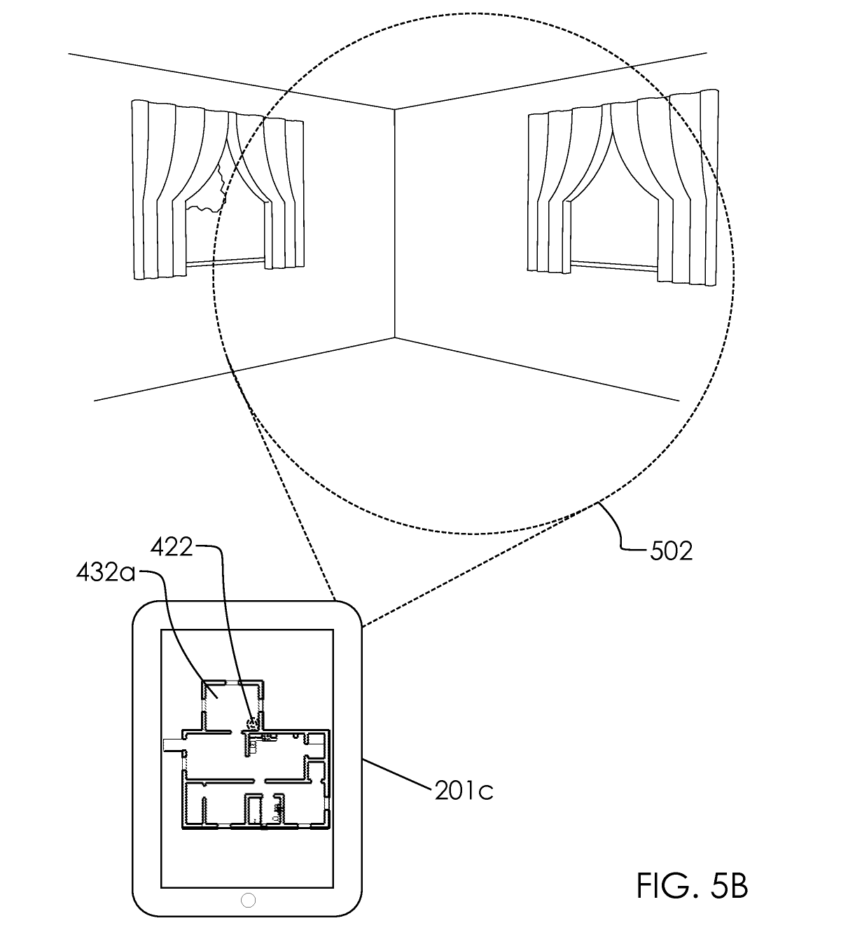

FIGS. 5A and 5B illustrate a perspective overview of said mobile computer 201c taking a digital image said second room 432b (comprising a subject matter 502), and said first room 432a. In one embodiment, said mobile computer 201 c can take pictures of various parts of said house 300 as a user updates said location icon 422 to provide a location coordinate for said virtual structural staging system 100 along with images of said one or more rooms. In one embodiment, images of said one or more rooms can be entered into said virtual structural staging system 100 by uploading or loading previously captured images into said virtual structural staging system 100; thereby avoiding the step of taking new pictures of said virtual structural staging system 100 if doing so is inconvenient or if said mobile computer 201 c does not appropriate equipment. This approach may also be used in the case where said virtual structural staging system 100 is run in a web browser rather than an app.

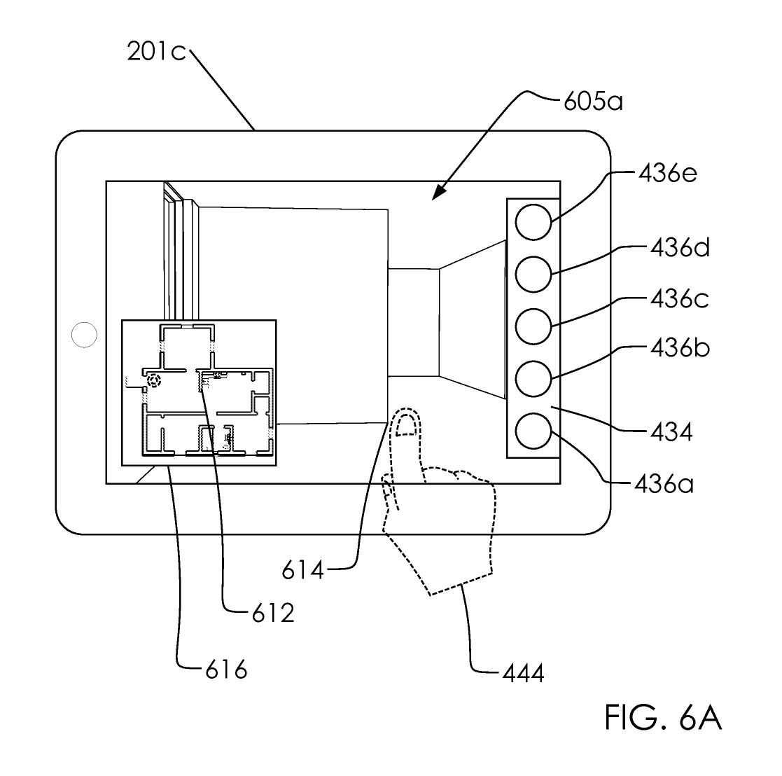

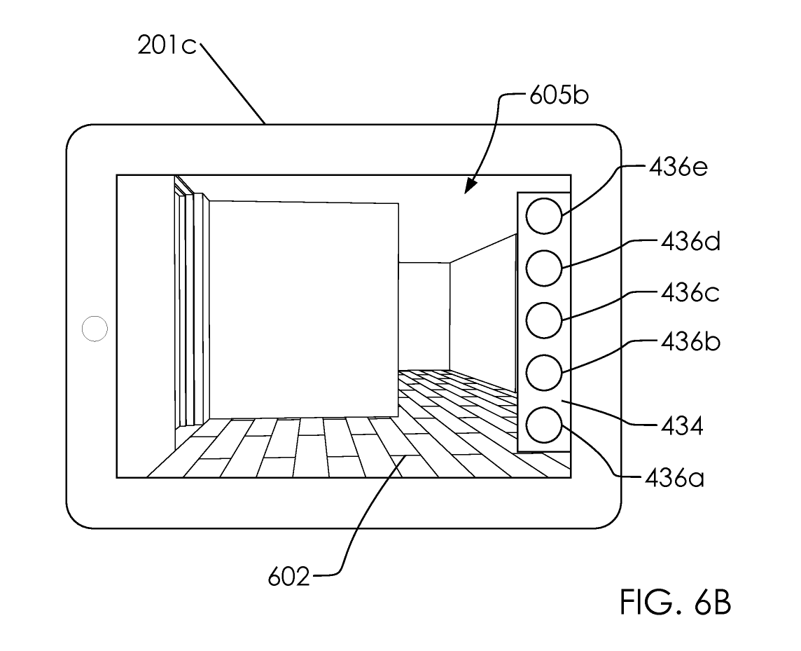

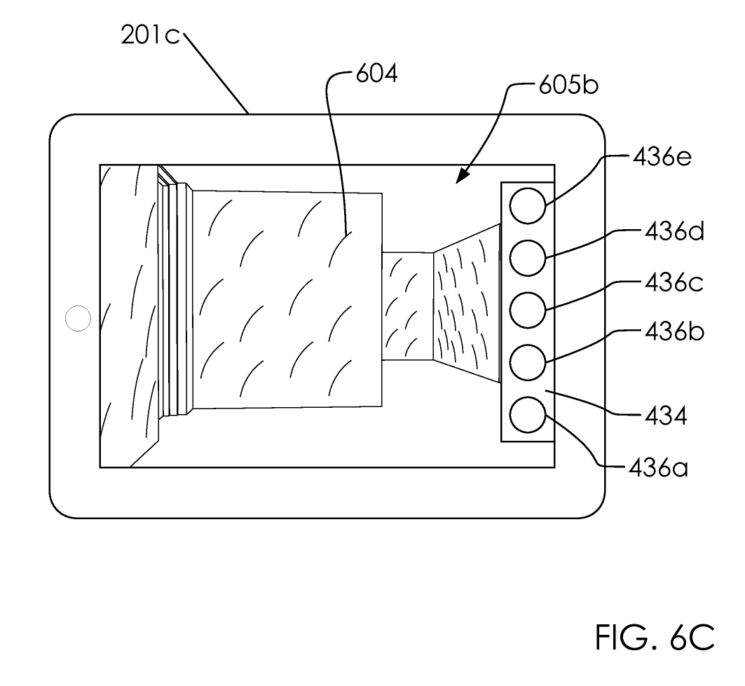

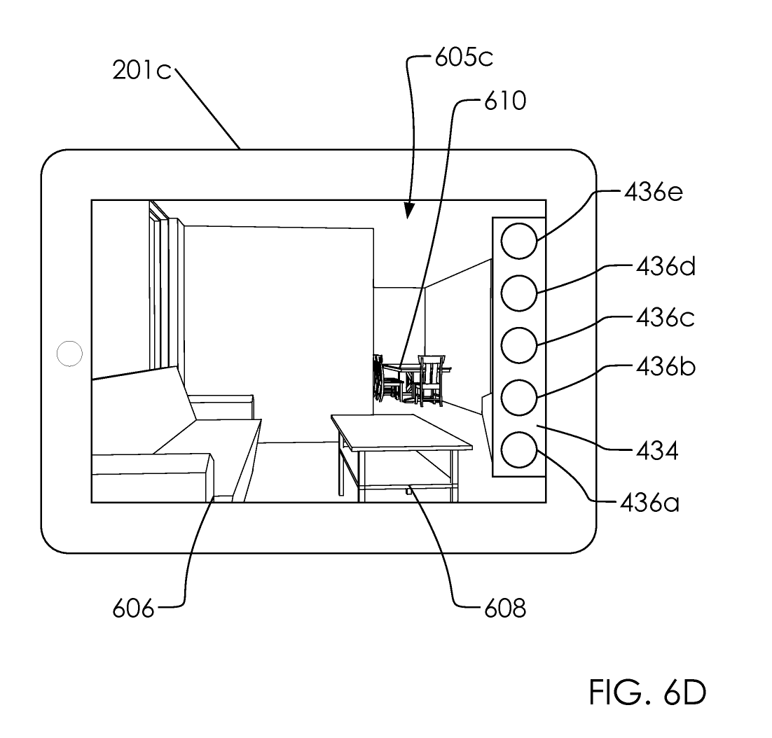

FIGS. 6A, 6B, 6C and 6D illustrate an elevated front view said mobile computer 201c comprising said virtual structural staging system 100 a perspective overview of said second room 432b; first as an original image 605a of an empty room, next as a first rendered image 605b comprising a flooring 602, then as a second rendered image 605c comprising a wall decor 604, and finally as a third rendered image 605c comprising a one or more furniture pieces (which can comprise a couch 606, a coffee table 608 and a kitchen table 610). In one embodiment, said virtual structural staging system 100 can render a one or more virtual improvements to said house 300 such as said flooring 602, et al.

Turing to FIG. 6A, it is illustrated that said hand 444 of a user of said virtual structural staging system 100 can trace out one or more vertices on said original image 605a and a floor plan 404 included on this screen as a key 616. For example, in one embodiment, a user of said virtual structural staging system 100 can touch a virtual vertex 612 on said key 616 and then touch a picture vertex 614 on said original image 605a. In one embodiment, said virtual vertex 612 and said picture vertex 614 correspond to one another as mapping to the same point of said house 300. In one embodiment, said virtual structural staging system 100 can prompt said user to map a plurality of virtual vertices to a plurality of picture vertices to as to construct a 3D model of said house 300 (later introduced as a rendered 3D floor plan 800). Accordingly, said virtual structural staging system 100 can add said flooring 602, said wall decor 604 and/or said one or more furniture pieces, as illustrated in renderings 605a-c.

In computer graphics, objects are most-often represented as triangulated polyhedra. Non triangular surfaces can be converted to an array of triangles through tessellation. The vertices of triangles are associated not only with position but also with other graphical attributes used to render the object correctly. Such attributes can include color at the vertex point, reflectance of the surface at the vertex, textures of the surface at the vertex, and the normal of an approximated curved surface at the location of the vertex. These properties are used in rendering by a vertex shader or vertex pipeline.

The normal can be used to determine a surface's orientation toward a light source for flat shading using Lambert's cosine law, or the orientation of each of the vertices to mimic a curved surface with Phong shading.

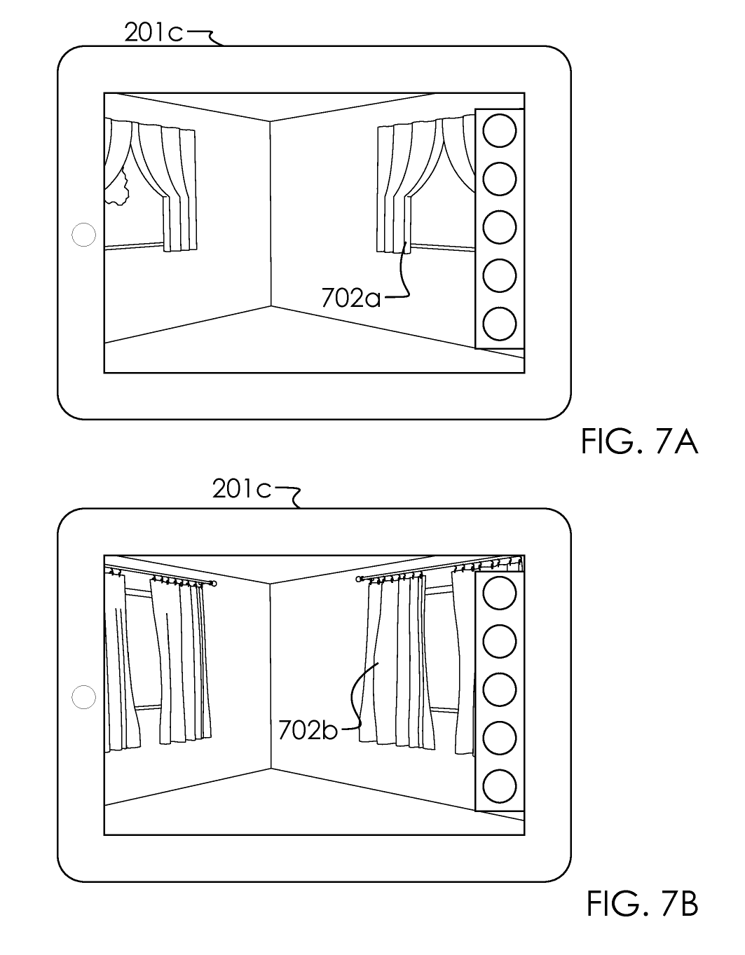

FIGS. 7A and 7B illustrate an elevated front view said mobile computer 201c comprising said first room 432a comprising a portion of said interior of said house 300 with different variations of a one or more window treatments. In one embodiment, said virtual structural staging system 100 can render one or more among said one or more window treatments (which can comprise a first window treatment 702a and a second window treatment 702b).

Of course, there are many different types of window treatments which may be rendered by said virtual structural staging system 100, such as curtains (as illustrated), cornices, lambrequins, swags, jabots, valences and/or similar. Said virtual structural staging system 100 can render any among a range of window treatments.

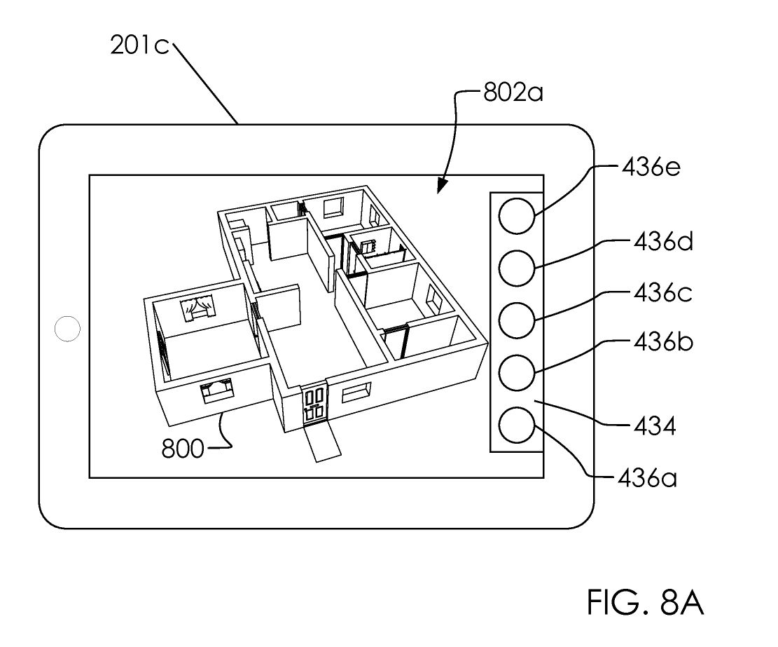

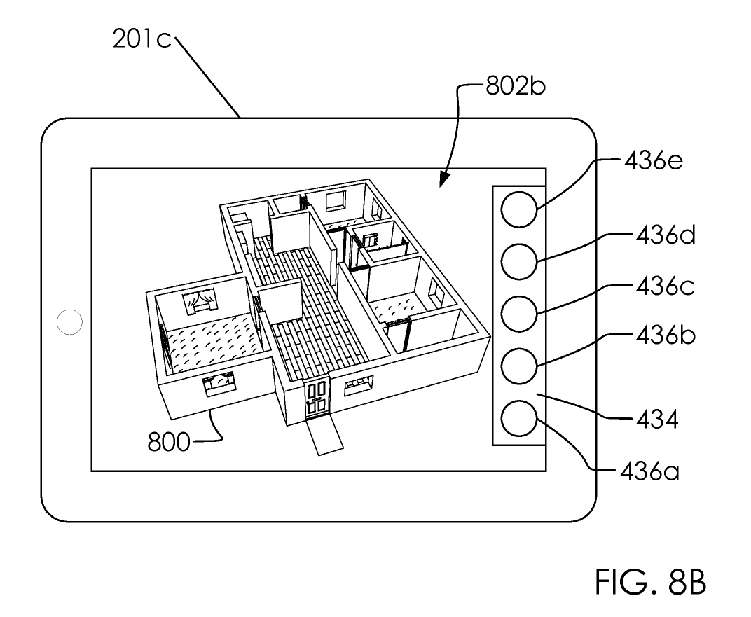

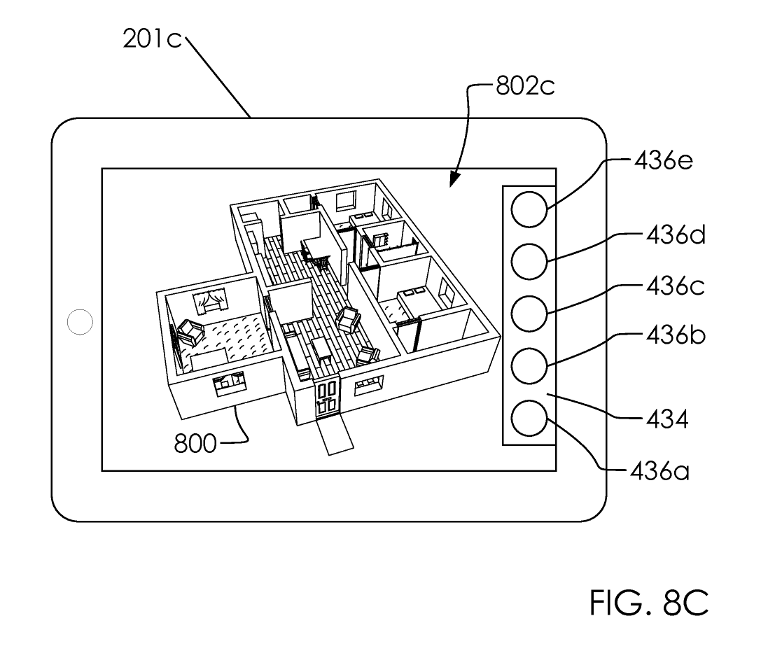

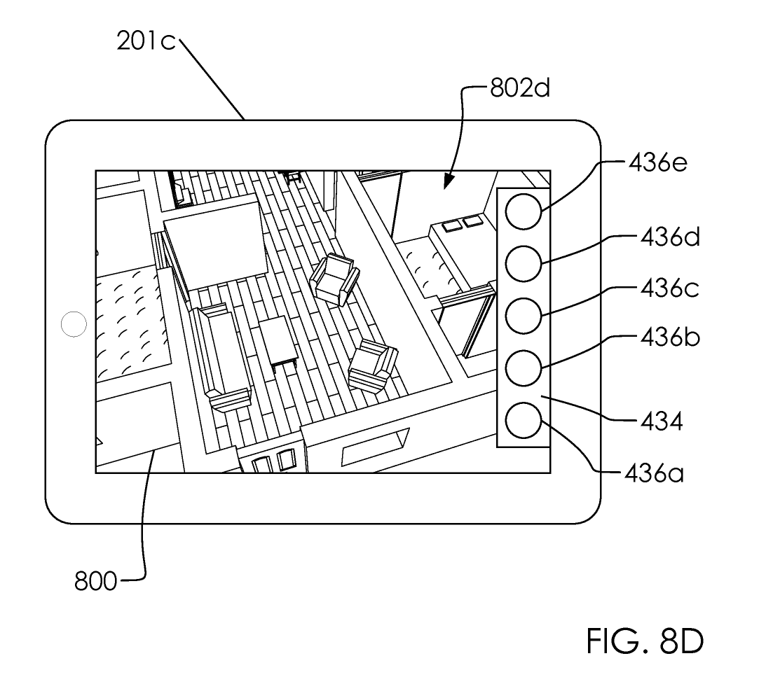

FIGS. 8A, 8B, 8C and 8D illustrate an elevated front view said mobile computer 201c comprising a rendered 3D floor plan 800 (comprising perspective 3-dimensional overview of said house 300); a first rendering 802a with said house 300 being empty, a second rendering 802b comprising the addition of a plurality of said flooring 602, a third rendering 802c further comprising a plurality of said one or more furniture pieces, and a fourth rendering 802d showing a detailed view of said second room 432b. In one embodiment, said renderings 802a-d of said house 300 can omit the inclusion of a roof and/or ceilings to facilitate overviews, as illustrated.

In one embodiment, said one or more buttons can be used for a plurality of purposes other than those described heretofore. For example, in one embodiment, said first button 436a can be used to “share” said digital image 405 of said floor plan 404, by sending as an email, publishing on a “social network”, such as Facebook and Twitter or for a plurality of other purposes. In one embodiment, said second button 436b can be used to change said type of flooring 602 of said digital image 405 of said floor plan 404 or for a plurality of other purposes. In one embodiment, said third button 436c can be used to alter and re-render said wall decor 604, such as changing wall texture, color, wallpaper, window treatments and said one or more interior or exterior doorways of said rendered 3D floor plan 800 or for a plurality of other purposes. In one embodiment, said fourth button 436d can be used to add or delete said furniture from said digital image 405 of said floor plan 404 or for a plurality of other purposes. In one embodiment, said fifth button 436e can be used to view said digital image 405 of said floor plan 404 by showing all in the current view, touring the structure, turning around by standing in one spot and turning about in a circle or for a plurality of other purposes of viewing said digital image 405 of said floor plan 404.

Note that in one embodiment, this system could be operated in a web browser rather than an installed app on a mobile device. Web based 3D rendering software are sufficiently advanced and well-known enough such that this disclosure need not discuss these technological methods further.

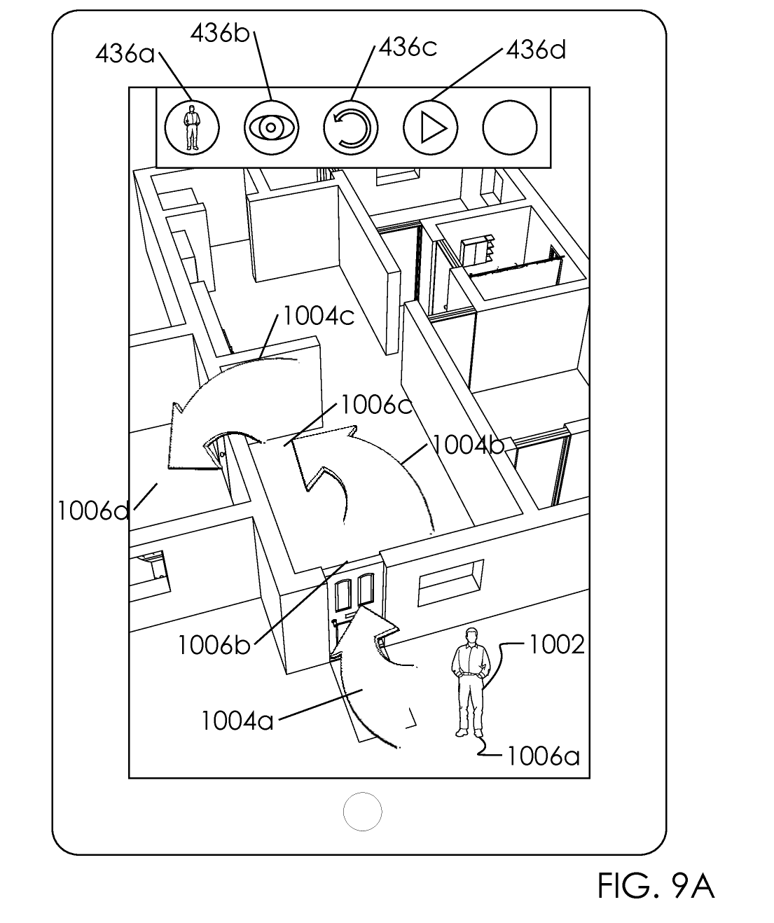

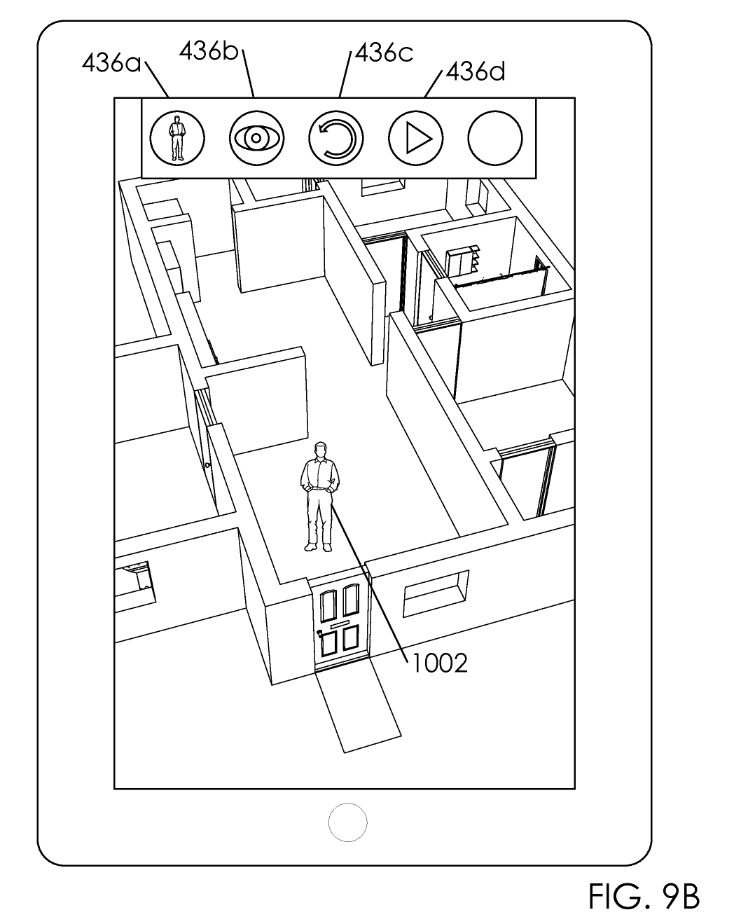

FIGS. 9A and 9B illustrate an elevated front view said mobile computer 201c comprising said rendered 3D floor plan 800 further comprising an avatar 1002 displayed as touring said rendered 3D floor plan 800. In one embodiment, said avatar 1002 can be placed at a first location 1006a and move to a second location 1006b by way of a first stroke 1004a and move to a third location 1006c by way of a second stroke 1004b and move to a fourth location 1006c by way of a third stroke 1004d. In one embodiment, said one or more buttons can be used to navigate said avatar 1002 through said house 300. For example, in one embodiment, said first button 436a can be used to place said avatar at a first location 1006a. In one embodiment, said second button 436b can be used to “look around” said house 300. In one embodiment, said third button 436c can be used to “undo” a move done by an operator of said mobile computer 201c. In one embodiment, said fourth button 436d can be used to “play” through the floor plan during a touring mode.

Accordingly, in one embodiment, said virtual structural staging system 100 can render a walkthrough of said rendered 3D floor plan 800 by mapping a path comprising a plurality of locations in said rendered 3D floor plan and rendering a point of view animation through said path.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other.

Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An apparatus, comprising:
at least a one memory of a one or more computers including a computer program code comprising a virtual structural staging system; and
at least one processor,
wherein the at least one memory and the computer program code are configured to, with the at least one processor, cause the apparatus at least to
capture a one or more digital images of a house having a floor plan;
map a plurality of virtual vertices of a rendered 3D floor plan over a plurality of picture vertices of said one or more digital images; and
render said rendered 3D floor plan in said virtual structural staging system on said at least one processor.

2. A method for processing a virtual structural staging system, the method comprising:
capturing a one or more digital images of a house having a floor plan;
mapping a plurality of virtual vertices of a rendered 3D floor plan over a plurality of picture vertices of said one or more digital images; and
rendering said rendered 3D floor plan in said virtual structural staging system.

3. The method of claim 2 wherein mapping said plurality of virtual vertices of said rendered 3D floor plan over said plurality of picture vertices of said one or more digital images comprises:
capturing a floor plan of said house as a first of said one or more digital images; and
for one or more images of a one or more one or more rooms of said house
identifying a location icon on said floor plan,
alternatively inputting a picture vertex and a virtual vertex, and
rendering said rendered 3D floor plan based on said one or more digital images, said plurality of virtual vertices.

4. The method of claim 3 further comprising:
rendering said house with a one or more virtual improvements in said rendered 3D floor plan.

5. The method of claim 3 further comprising:
rendering said house with a flooring in said rendered 3D floor plan.

6. The method of claim 3 further comprising:
rendering said house with a wall decor in said rendered 3D floor plan.

7. The method of claim 3 further comprising:
rendering said house with a one or more furniture pieces in said rendered 3D floor plan.

8. The method of claim 3 further comprising:
rendering said house with a one or more window treatments in said rendered 3D floor plan.

9. The method of claim 3 further comprising:
processing and rendering said virtual structural staging system in a mobile computer.

10. The method of claim 3 further comprising:
processing said virtual structural staging system in a server, and
rendering said virtual structural staging system in a web browser on a mobile phone.

11. The method of claim 3 further comprising:
processing said virtual structural staging system in a server, and
rendering said virtual structural staging system in a web browser on a personal computer.

12. The method of claim 3 further comprising:
mapping a path comprising a plurality of locations in said rendered 3D floor plan; and
rendering a walkthrough of said rendered 3D floor plan according to said path.

13. The method of claim 12 wherein said walkthrough comprises a point of view animation through said path.

14. The method of claim 12 wherein mapping a path in said rendered 3D floor plan comprises:
placing an avatar in said rendered 3D floor plan; and
moving said avatar with a one or more strokes on between said plurality of locations.

15. A computer program product embodied on a non-transitory computer readable storage medium, the computer program product being encoded with instructions to control a processor to perform a process, the process comprising:
